(19) United States
(12) Patent Application Publication
(10) Pub. No.: US 2026/0356345 A1
(43) Pub. Date: Nov. 12, 2026

(54) BATTERY CHARGE CURRENT REGULATION AND TORQUE ALLOCATION CONTROL FOR A FLOATING HIGH VOLTAGE BUS ARCHITECTURE

(71) Applicant: GENERAL DYNAMICS LAND SYSTEMS, INC., Sterling Heights, MI (US)

(72) Inventors: John William Kelly, Troy, MI (US); Brian James Vera-Burgos, Rochester Hills, MI (US); Dan Paul Rakowski, Sterling Heights, MI (US); Brad Paul Wheelis, Chesterfield Twp, MI (US); Chris Edward Cinpinski, Richmond Twp, MI (US); Thomas Patrick Goldenbogen, Chesterfield Twp, MI (US)

(73) Assignee: GENERAL DYNAMICS LAND SYSTEMS, INC., Sterling Heights, MI (US)

(21) Appl. No.: 19/390,206

(22) Filed: Nov. 14, 2025

Related U.S. Application Data
(60) Provisional application No. 63/719,791, filed on Nov. 13, 2024.

(51) Int. Cl. B60W 20/10; B60W 10/08; B60W 10/26

(52) U.S. Cl. CPC B60W 20/10; B60W 10/08; B60W 10/26

(57) ABSTRACT

A vehicle system includes a high-voltage electrical machine (HVEM) sourced by an inverter that functions as a vehicle drive as well as the primary HV power generation component of the vehicle. The HVEM may also serve several motoring functions, such as crank for internal combustion engine (ICE), supplemental torque (i.e., boost) to the ICE, and limited electrical-only propulsion. Sourcing/loading the system is a Li-ion battery system. A high voltage power distribution controller (HVPDC) manages the HVEM and battery system to ensure electrical power availability and quality (i.e. a stable HV Bus). In addition, the HVPDC provides: pre-charge capability, cable protection, power measurements, and HV operational advantages (e.g., ground fault detection, HVIL, HV Bus potential zeroing via rapid and controlled capacitance bleed down).

### CROSS REFERENCE TO RELATED APPLICATION

This application claims the benefit of U.S. Provisional Application No. 63/719,791, filed on Nov. 13, 2024, which is expressly incorporated by reference herein.

### TECHNICAL FIELD

The present disclosure relates to high voltage (HV) bus architectures and more particularly to battery charge current regulation and torque allocation control for such architectures.

### BACKGROUND

A high voltage (HV) subsystem includes the various power related devices attached to the HV electrical bus, and the coordinating controls for these devices. These devices fall into four categories: (i) HV electrical power generation devices such as electrical machines and motor/generators; (ii) HV electrical power distribution and protection devices such as transistor-based load switch and fuses; (iii) voltage conversion devices such as DC-DC convertors and DC-AC invertors; and (iv) HV electrical power storage devices such as Li-ion batteries and fuel cells.

The components of these four groups form the various power architectures of all modern electric vehicles. Over the last four decades the transportation industry has been dedicating research efforts into advancing each of these component groups, to facilitate the realization of electrification and its benefits by continuing to replace (or enhance) conventional subsystems with electrical ones. This electrification evolution was made possible by three major technologies: 1) advanced power electronics, 2) higher capacity batteries, and 3) the sensor and computation capability to realize advance control theory. In light of these advancements, there is a need to develop a high voltage (HV) subsystem control strategy to meet the needs of various HV platforms, particularly as it relates to deployment in electric vehicle applications.

### SUMMARY

The vehicle systems described herein include a high-voltage electrical machine (HVEM) sourced by an inverter that functions as a vehicle drive as well as the primary HV power generation component for the vehicle. The HVEM may also serve several motoring functions, such as crank for internal combustion engine (ICE), supplemental torque (i.e., boost) to the ICE, and limited electrical-only propulsion. Sourcing/loading the system is a Li-ion battery system. A high voltage power distribution controller (HVPDC) manages the HVEM and battery system to ensure electrical power availability and quality (i.e. a stable HV floating bus). In addition, the HVPDC provides: pre-charge capability, cable protection, power measurements, and HV operational advantages (e.g., ground fault detection, HVIL, HV Bus potential zeroing via rapid and controlled capacitance bleed down).

The methods described herein provide current regulation for a high voltage subsystem including a high voltage electric machine (HVEM) and a high voltage battery on a high voltage floating bus in a vehicle having a powertrain selectively driven by an internal combustion engine (ICE) and operably coupled to the HVEM. An available torque value is determined for the ICE. A driving torque value is measured for propulsion of the vehicle. A battery charge command including a desired charge current is received by a high voltage power distribution controller. The high voltage subsystem is operated in a voltage regulation mode to regulate a current generated by the HVEM on the high voltage floating bus when the ICE is generating sufficient torque to propel the vehicle and to charge the HV battery. The high voltage subsystem is operated in a torque allocation mode to regulate the current generated by the HVEM on the high voltage floating bus, wherein the HVEM is selectively operated to generate a supplemental torque for assisting the ICE and to regulate the current on the high voltage floating bus for maintaining a state of charge for the high voltage battery.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations and are not intended to limit the scope of the present disclosure.

FIG. 1 illustrates a convention chassis power architecture;

FIG. 2 illustrates the functional modes in accordance with the control strategy described herein;

FIG. 3 illustrates a top level state transitions in accordance with the control strategy described herein;

FIG. 4 illustrates 1st order RC equivalent battery model in accordance with the control strategy described herein;

FIG. 5 illustrates a load model in accordance with the control strategy described herein;

FIG. 6 illustrates a close loop model for battery current regulation in accordance with the control strategy described herein;

FIG. 7 illustrates a control law using a load current feedforward term in accordance with the control strategy described herein;

FIG. 8 illustrates a torque allocation realization including a dynamic saturation control block in accordance with the control strategy described herein;

FIG. 9 illustrates a plot showing the generator speed vs power curve in accordance with the control strategy described herein;

FIG. 10 illustrates a speed vs power assessment in accordance with the control strategy described herein;

FIG. 11 illustrates a voltage (SoC) assessment in accordance with the control strategy described herein;

FIG. 12 illustrates a HV subsystem battery charge current control scheme in accordance with the control strategy described herein;

FIG. 13 illustrates a HV subsystem model used for generation simulation in accordance with the control strategy described herein;

FIG. 14 illustrates a battery charger controller in accordance with the control strategy described herein;

FIG. 15 is a plot showing time vs. state of charge and desired charge current in accordance with the control strategy described herein; and

FIG. 16 is a plot showing time vs. state of charge and torque allocation in accordance with the control strategy described herein.

### DETAILED DESCRIPTION

Example embodiments will now be described more fully with reference to the accompanying drawings.

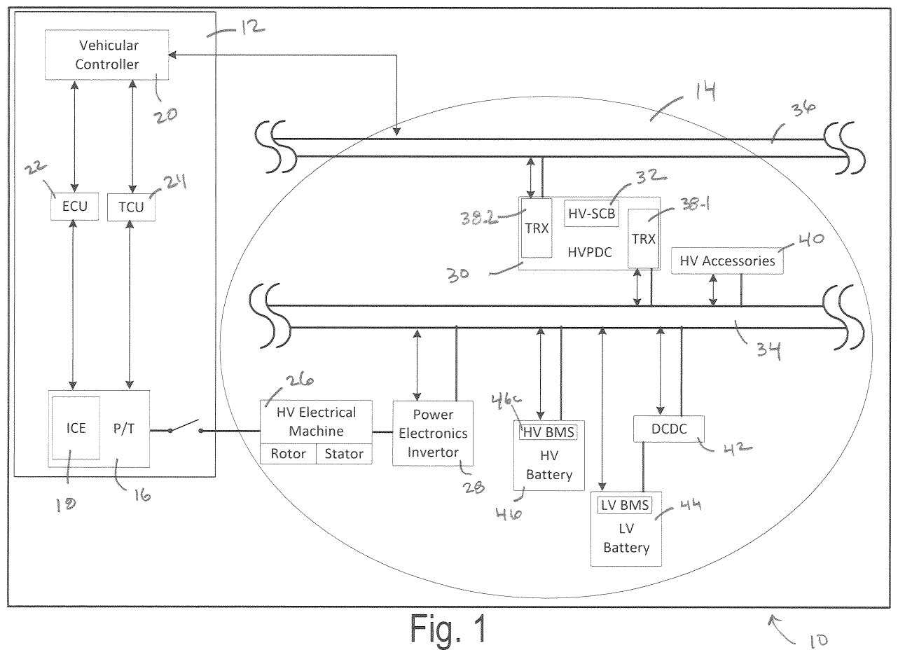

With reference to FIG. 1, a vehicle, schematically shown at 10 includes a vehicular subsystem 12 and a high voltage (HV) subsystem 14. In a simplified form, the vehicular subsystem 12 includes a powertrain 16 having an internal combustion engine 18 and various controllers such as vehicular controller 20, engine control unit 22 and transmission control unit 24. The HV subsystem 14 includes an HV electrical machine (HVEM) 26, which is sourced by an inverter 28. In a driven mode, the HVEM 26 functions to provide the primary high-voltage power generation delivered to a high voltage bus 34 of the vehicle 10. In a drive mode, the HVEM 26 functions as a starter/electric motor producing torque for various operating conditions of the vehicle 10, namely: i) cranking an internal combustion engine (ICE) 18 for engine starting; ii) boosting the torque produced by the ICE 18 for electro-mechanical propulsion; and iii) driving the powertrain 16 for limited electrical propulsion. By virtue of the bi-modal operation (motor/generator) of the HVEM 26, it may also be referred to as an integrated starter-generator or ISG.

### HV Power Distribution Controller

The HV subsystem 14 also includes a high voltage power distribution controller or HVPDC 30 is configured with fuse protection. While individual load channel smart control may be enabled in place of fuse protection, it has been determined that the increased performance from smart load channel control may not justify the increased cost and thermal burden for this effort. The HVPDC 30 may include two compact cable protection modules (CCPM) having up to eight fused channels, with current sensing and fuse state detection for each channel. As noted previously, the HVPDC 30 provides and manages necessary high voltage safety features.

The HVPDC 30 realizes a control strategy using a high-voltage sensors and control board (HV-SCB) 32. All sensor measurements and external data processing are conducted by the HV-SCB 32. With this information, the HV-SCB 32 generates the necessary commands to realize the HV subsystem control strategy further detailed below.

### Communications

All major high voltage components are linked via the HV subsystem CAN bus 34 that is purposely dedicated to HV line replaceable units (LRUs) for two major reasons: first, to preserve a deterministic nature for control implementation (i.e., minimal LRUs on the CAN bus to prevent delays in transmitting/receiving, feedback/commands); and second, to provide HV protection (ensuring a HV transient is not propagated to non-HV hardened LRUs). Other vehicle control components are linked via the vehicular subsystem CAN bus 36. The HVPDC 32 has two isolated CAN transceivers 38.1, 38.2—one transceiver 38.1 coupled to the HV subsystem CAN bus 34 for communicating with various HV LRUs (e.g., HV accessories 40, DC-DC convertor 42, LV battery 44, HV battery 46), and the other transceiver 38.2 coupled to the vehicular subsystem CAN bus 26 for communication with the vehicle controller 20 (mode commands and statuses).

Below is a summary of CAN ICD between the HVPDC 32 and the vehicle controller 20:

### Vehicle Controller 20 to HVPDC 32:

Mode
Torque command (for all motoring operation, e.g., ICE crank, ICE boost, silent propulsion)
Torque allocation (for generator operation)
Battle override (discrete)

### HVPDC 32 to Vehicle Controller 20:

Actual mode
Faults/warnings
Battery SoC
Actual (estimated, ~Iₚₕₐₛₑ) generator/motor torque
Torque request for max battery charging and HV load
Generator speed request for max power (i.e. max battery charging)

### Control Strategy Applied to HV Subsystem

The control strategy of the HV Subsystem 14 can be divided into two echelons: 1) modes and states; and 2) battery current regulation with torque allocation in the generation mode.

### Modes and States

The HVPDC 30 has several commanded modes, which include: i) HV pre-charge, ii) ICE crank, iii) electrical power generation-current control; iv) electrical power generation-voltage control (generator only mode; v) ICE torque boost; vi) electric propulsion; vii) silent watch; viii) LV to HV boost, ix) HV export and import, and x) HV shutdown. Non-commanded modes include: a) Shutdown; b) Fault; and c) Reset. The states are decision points in the control strategy for realizing the various commanded modes. There may be over one hundred States associated with the HV Subsystem state transition diagram.

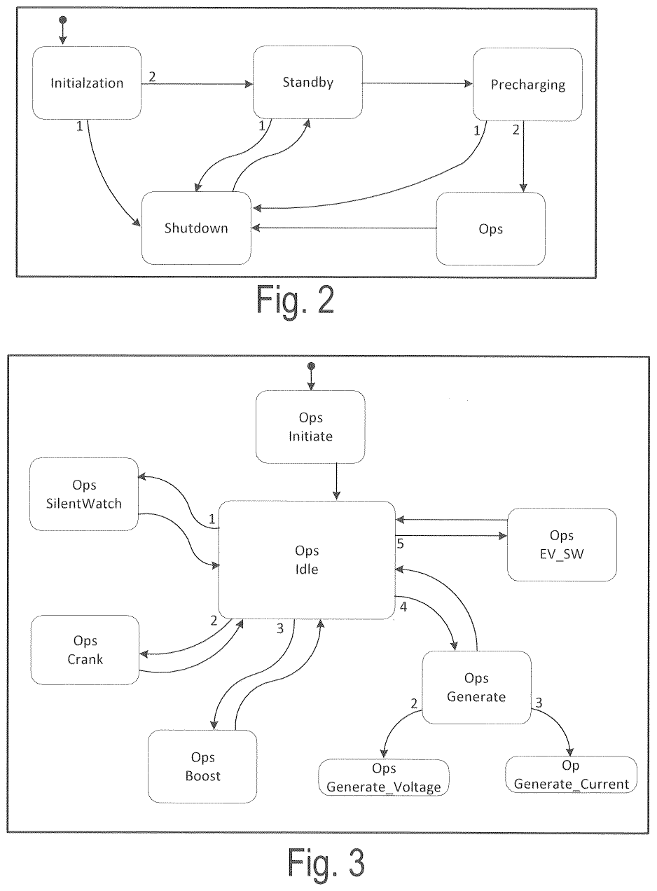

FIG. 2 illustrates an example of the States transitions. FIG. 3 illustrates an example of the Modes transition. Each of the States transitions shown in FIG. 2 and the Modes transitions shown in FIG. 3 may be realized using a Stateflow tool in MATLAB. MATLAB is a proprietary multi-paradigm programming language and numeric computing environment developed by MathWorks, which allows for expedient transition to code. The actual code may be autogenerated from the Stateflow environment.

### HV Subsystem Battery Current Regulation Control

A reduced order plant model of the HV subsystem consists of three major components: the HV battery, a HV load, and a generator/inverter. Only the equivalent circuits of the HV battery and HV load are further described below, since the generator/inverter, which is assumed to have a much higher bandwidth, can be treated as gain with its dc-link capacitor combined with the load impedance.

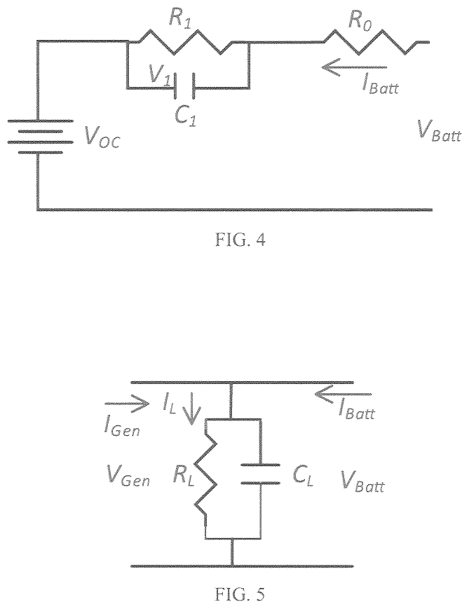

A first order RC equivalent battery model, as shown in FIG. 4, is defined by the following equations:

$${I}_{Battery} = \frac{{V}_{1}}{{R}_{1}} + {C}_{1} \frac{{dV}_{1}}{dt} \qquad ( 1 )$$

$${V}_{Battery} = {V}_{OC} + {V}_{1} + {I}_{Battery} {R}_{0} \qquad ( 2 )$$

$${V ( s )}_{Battery} = {V ( s )}_{OC} + {I ( s )}_{Battery} [ \frac{{R}_{1}}{1 + {C}_{1} {R}_{1} s} + {R}_{0} ] \qquad ( 3 )$$

$${k ( s )}_{1} = [ \frac{{R}_{1}}{1 + {C}_{1} {R}_{1} s} + {R}_{0} ] \qquad ( 3 a )$$

$${V ( s )}_{Battery} = {V ( s )}_{OC} + {I ( s )}_{Battery} {k ( s )}_{1} \qquad ( 3 b )$$

An equivalent HV load model, as shown in FIG. 5, is defined by the following equations:

$${I}_{Load} = {I}_{Battery} + {I}_{Generator} \qquad ( 4 )$$

$$\frac{{V}_{Battery}}{{R}_{L}} + {C}_{L} \frac{{dV}_{Battery}}{dt} = {I}_{Battery} + {I}_{Generator} \qquad ( 5 )$$

which when converted to Laplace are represented as follows:

$${V ( s )}_{Battery} [ \frac{1 + {R}_{L} {C}_{L} s}{{R}_{L}} ] = {I ( s )}_{Battery} + {I ( s )}_{Generator} \qquad ( 6 )$$

$${k ( s )}_{2} = [ \frac{1 + {R}_{L} {C}_{L} s}{{R}_{L}} ] \qquad ( 6 a )$$

$${V ( s )}_{Battery} = \frac{{I ( s )}_{Battery} + {I ( s )}_{Generator}}{{k ( s )}_{2}} \qquad ( 6 b )$$

And equating 6b and 3b provides:

k(s)₂V(s)_{OC}+I(s)_{Battery}[k(s)₁k(s)₂−1]=I(S)_{Generator} (7)

The electrical dynamics of the generator are significantly faster than the battery and load dynamics, thus the gain between generator torque and output generator current is proportional and represented as a steady-state relationship between an electrical machine (toque and phase current) by the following equation:

τ~I_{Generator} (8)

Equating the mechanical and electrical power of the electrical machine provides:

τωᵣₒₜₒᵣ=(VI)_{Generator} (9)

And equating this equation (9) with equation (7) yields:

$${k ( s )}_{2} {V ( s )}_{OC} + {I ( s )}_{Battery} [ {k ( s )}_{1} {k ( s )}_{2} - 1 ] = τ [ \frac{ω ( s )}{{V}_{Generator}} ] \qquad ( 10 )$$

$${k ( s )}_{2} {V ( s )}_{OC} [ \frac{{V}_{Generator}}{ω ( s )} ] + {I ( s )}_{Battery} [ \frac{{R}_{1} + {R}_{1} {R}_{L} {C}_{L} s}{{R}_{L} + {C}_{1} {R}_{1} s} + \frac{{R}_{0} + {R}_{0} {R}_{L} {C}_{L} s}{{R}_{L}} - 1 ] [ \frac{{V}_{Generator}}{ω ( s )} ] = τ \qquad ( 11 )$$

Equation (10) may be simplified by eliminating the nonlinear voltage term and assuming R₁<<R_{L}:

$${I ( s )}_{Battery} [ \frac{{R}_{0} + {R}_{0} {R}_{L} {C}_{L} s}{{R}_{L}} - 1 ] [ \frac{{V}_{Generator}}{ω ( s )} ] = τ \qquad ( 12 )$$

As shown in equation (12) the battery current is related to the generator torque by two terms. The first term represents the simplified plant dynamics, while the second is the power conversion term. The speed, ωᵣₒₜₒᵣ, and battery voltage, V_{oc}, change relatively slowly compared to the possible change in load, R_{L}. Thus, the controller will be less responsive for sudden load changes. To compensate for sudden load changes, the load current is measured and added to the measured battery current.

$$[ {I ( s )}_{Battery} [ \frac{{R}_{0} + {R}_{0} {R}_{L} {C}_{L} s}{{R}_{L}} ] - {I}_{Load \_ Measured} ] [ \frac{{V}_{Generator}}{ω ( s )} ] = τ \qquad ( 13 )$$

Based on this model a closed loop compensator and its gains are implemented to maximize current response.
Control Theory Realization: Battery Charge Current Regulation with Torque Allocation

The architecture for the HV subsystem 14 is designed around a floating HV bus 34, i.e. the HV battery state of charge (SoC) determines the bus voltage. The floating bus architecture is preferred over fixed/regulated voltage level bus, to allow a seamless transition between power generation mode and engine torque boost mode of the HVEM 26. Also, with the HV battery determining the bus voltage, the HVEM 26 is free to operate in torque mode, which provides means for regulating battery charging current, and the ability to control the relationship between an internal combustion engine (ICE) 18 and HV battery 46 (i.e., overall vehicle performance optimization by utilizing HV battery as load or source).

The ideal ISG inverter mode of operation for the HVEM 26 is voltage regulation with current/torque control (i.e. dynamic limiting). The outer voltage control loop ensures the HV battery 28 is never overcharged, while the controllable inner current loop allows for battery charge current regulation. This control scheme requires management of nonlinear saturation effects.

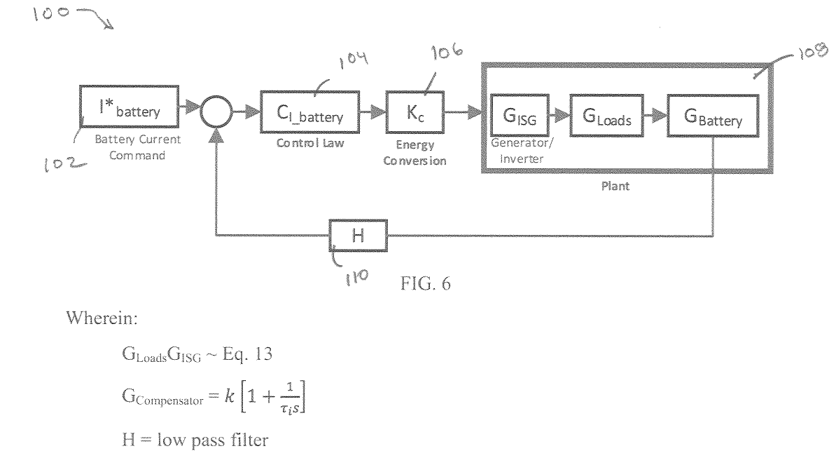

The control strategy 100 implemented by the HVPDC 32 is derived to regulate the HV battery current. As illustrated in FIG. 6, the control strategy 100 receives a battery current command at block 102 which is applied as an input to a control law at block 104 and an energy conversion factor at block 106 that is fed to the plant at block 108. By setting the battery current command at block 102 to zero, the HVEM 26 produces enough power to support the HV Bus 34. Any load transients will result in a change of battery current, and thus the HVPDC 32 adjusting the torque of the HVEM 26 to compensate.

The HV Battery 46 broadcasts a desired charge current, I_{charge_max}, that provides feedback as represented at block 110 in the control strategy 100. This value is based on battery conditions, e.g., temperature, state of charge (SoC) and state of health (SoH). As the SoC increases, the desired charge current decreases. Therefore, the battery command current is set to the desired battery charge current.

$${I}_{battery}^{*} = {I}_{charge \_ m ax}$$

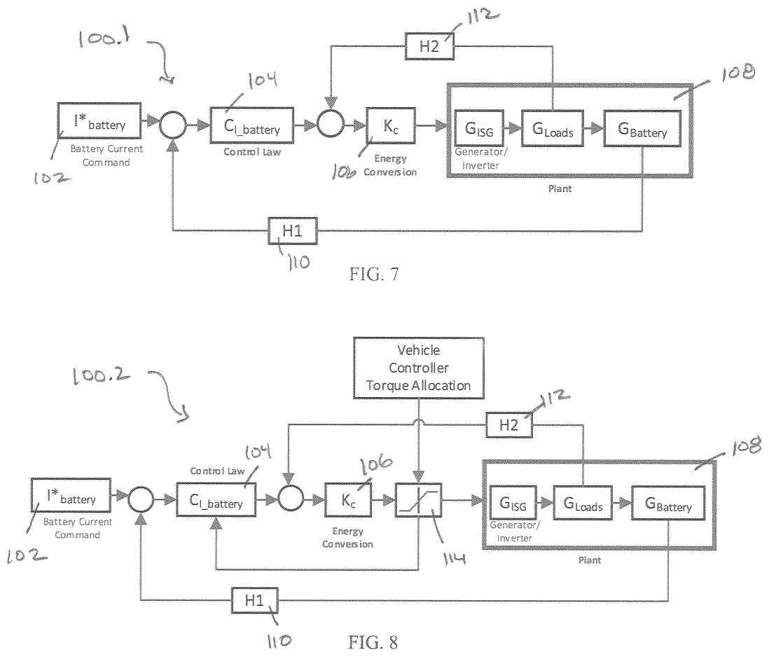

For a floating bus architecture, the battery current is continuously responding to load changes. Therefore, the control law at block 104 should have a bandwidth configured to limit the duration and depth of battery cycling. For faster response, a load current feedforward term H2 at block 112 is added to the control strategy 100′ as shown in FIG. 7.

### Torque Allocation

For the described control strategy 100, 100.1, it is assumed that adequate torque is available from the internal combustion engine (not shown) to be converted to electrical power. However, there may be cases, mission driven, where insufficient torque is available. In the case where the vehicle propulsion requires additional torque, a limit may be placed on the amount of mechanical to electrical conversion. In these cases, the vehicle supervisory controller 32 issues a torque allocation to the HVPDC 32. The HVPDC 32 limits the battery charging current proportionally to the maximum torque allocation. If additional torque is needed for propulsion, the vehicle supervisory controller 20 issues a zero-torque allocation. The HVPDC 32 would then issue a zero-torque command to the HVEM 26, and as a result, all HV loads would be sourced by the HV battery 46. Eventually, the vehicular controller 20 would issue a non-zero torque allocation, not letting the SoC drop too low.

The torque allocation limit is realized by proportionally limiting I_{charge_max}. FIG. 8 shows the addition of a dynamic saturation control block 114, as part of the overall control strategy 100.2. The difference between the desired torque and allocated torque is fed back to the control law block 104 to limit windup.

ISG Speed vs. Power Consideration

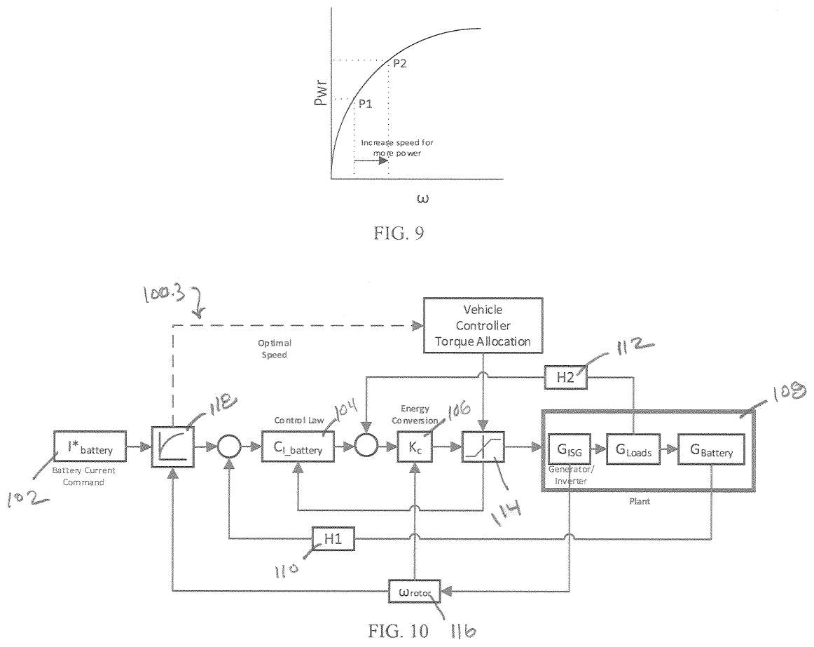

In addition to the vehicular controller 20 restricting torque, via torque allocation, the torque for electrical conversion could be restricted due to the speed of the HVEM 26 functions as an ISG. The output power of the ISG is a function of speed and torque as illustrated in FIG. 9, such that at lower speeds, the generator may not be able to produce the desired torque.

V_{battery}*I_{battery}=Power=τ*ω

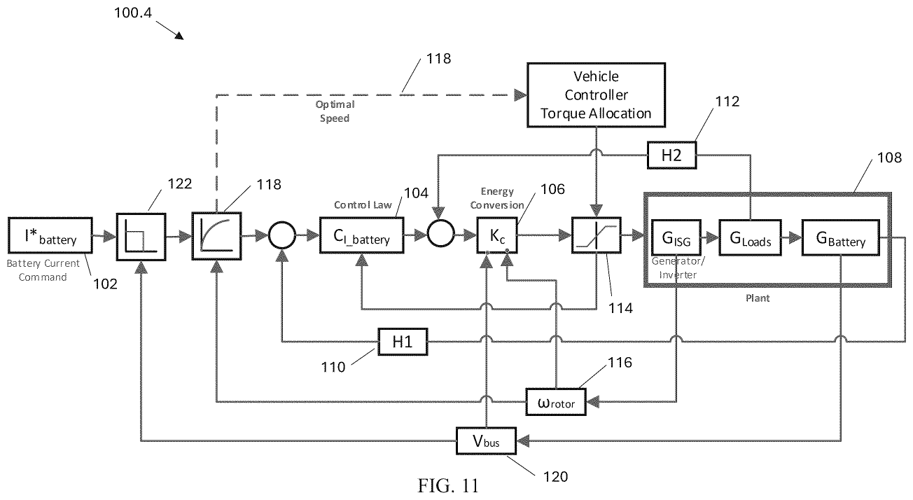

In the control strategy 100.3 illustrated in FIG. 10, the HVPDC 32 compares the desired torque at block 116 with the possible torque and limits the desired battery command accordingly. The HVPDC 30 will issue a warning at block 118 to the vehicular controller 20 that desired electrical power is not available. The vehicular controller 20 may choose to increase the speed via transmission gear change.

### Voltage Clamping

Finally, in the control strategy 100.4 illustrated in FIG. 11, another limiting factor for desired torque, is voltage clamping. If the voltage on the HV Bus 34 at block 120 reaches maximum battery limit, the HVPDC 32 will set I_{charge_max} to zero at block 122. (note: an additional SoC check can be implemented as well, however, voltage clamping is most reliable method, due to uncertainty of SoC algorithms.)

A model of the overall HV Subsystem 14 will be detailed below, along with simulation results. This model was developed to evaluate the performance of the control strategy for the HVPDC 32 set forth above.

### Control Strategy Realization

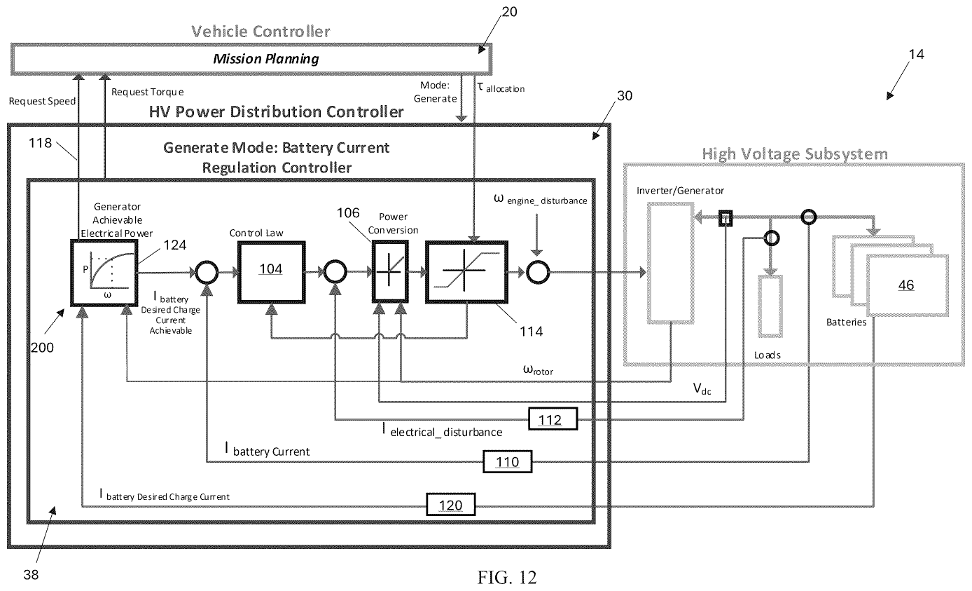

FIG. 12 schematically illustrates control of the HV subsystem 14 in current generation mode. After receiving the Mode command from the vehicular controller 20, the HVPDC 30 commands the HVEM 26 to produce the charging current requested by the HV battery 46. In addition to the Mode command, the vehicular controller 20 also issues a Torque Allocation command. This novel control scheme allows the vehicular controller 20 to reduce the battery charging current, to in turn, reduce the ICE torque load. An example of this action would be reducing maximum battery charge current to meet propulsion demands.

The HVPDC 30 implements a battery current regulation control strategy 200 as follows: First, the objectives (cost functions) of the HVPDC 30 are reviewed. These objectives may include: i) regulating battery charging rate not to exceed battery acceptable current levels; ii) maximum battery charging rate; iii) minimum battery discharge when in conventional propulsion mode; iv) stable HV bus; and v) HV power availability. Next, the disturbances to the HVPDC 30 are highlighted. Finally, safety features implemented into the control strategy 200 are reviewed.

### Control Objectives (Cost Functions)

The primary objective of the HV subsystem control strategy 200 is to regulate the battery charging current. Most Li-ion batteries publish a recommended maximum charge current. This value is based on cell temperatures and voltages, and overall SoC. High current charging of Li-ion batteries, at elevated temperatures, can prematurely reduce their energy capacity. Therefore, to preserve operating lifespan, suppliers determine the optimal charge.

### Maximum Battery Charging

The HVPDC 30 will normally charge the HV battery 46 as fast as the battery recommends, with two exceptions:
The maximum desired charge current does not exceed the rated the power of the generator; or
The maximum desired charge current does not exceed the torque allocation issued by the vehicle supervisory controller.

### Torque Allocation

A torque allocation quantity is issued to the HVPDC 30 by the vehicular controller 20 to regulate the amount of mechanical to electrical conversion. As discussed above, the HVPDC 30 will request the torque needed to charge at the maximum current rate. However, the vehicle controller 20 can limit the charging current (~charging torque). For example, if more torque is needed for propulsion, the battery charging can be slowed or halted. Therefore, the amount of conversion between mechanical and electrical, should be dictated by the overall mission. For example, if the vehicle acceleration is a high priority, the vehicular controller 20 can issue a 0% Torque Allocation to the HVPDC 30, which in turn command zero torque to the HVEM 26 functioning as a generator, and loads are sourced by the HV battery 46.

### Minimum Battery Discharging

With respect to the electrical power system, the purposes of the HV battery 46 is: 1) provide electrical power during silent watch, and 2) provide power for supplemental (or primary) torque for propulsion, and 3) provide load leveling for transient load conditions. The load leveling function duration should be minimal, to preserve charge, thus maintain vehicle readiness. The HVEM 26 functioning as a generator should react to any load changes immediately to lessen the draw on the HV battery 26. This can be challenging when operating the generator in a voltage regulation mode, with a floating bus architecture and usually requires inverter voltage loop gain scheduling. This is not an issue when the generator is operated in current mode.

### Power Availability

The third objective of the control scheme 200 is to ensure enough power is available for all loads including battery charging. With the increasing electrification of vehicles, and corresponding increasing dependency on the HV subsystem 14 for mission success, it is imperative that the HV bus 34 is managed independent of other subsystems, beholden only to the vehicular controller 20.

The conventional relationship between mechanical to electrical conversion, i.e., an alternator being a minor subcomponent to the ICE 18, is no longer sufficient. The advancement in power electronics and electromagnetics, along with high-capacity electrical storage systems, enables the use of a modern electrical drive (motor/generator) as a major vehicle component, converting large amounts of energy between mechanical and electrical systems. Under these circumstances, it is important to recognize the growing importance of the motor/generator, the integral nature of the component in the HV subsystem 14, and the need to retain direct control of it, with the HVPDC 30 issuing drive current/torque commands.

### Stable HV Bus

The fourth and final objective is stability of the HV bus 34. There are several measurements of bus stability, for example: (i) transient stability—minimize the effects, dV/dt and dI/dt (i.e. spikes), to large load disturbances; and (ii) asymptotic stability—the voltage and current quickly return to steady state after a disturbance.

### Disturbances

### Speed Variation

This control strategy 200 was developed for a parallel hybrid system with a floating bus, i.e. generator and battery directly connected. For this type of architecture, the rotor speed of the generator is a linear function of the engine speed, which varies depending on propulsion needs. This effects electrical generation in two ways. The first effect speed variation has on electrical power generation is related to Faraday's Law of Induction as described below with respect to the electromagnetic performance of the generator. The second effect speed has on the control scheme is related to the electromagnetic performance of the machine as described below.

### HV Bus Load Variations

HV load level on the HV bus 34 continuously changes, thus the HVPDC 30 must continuously adjust the generator torque command to compensate. To increase the responsiveness of the HVPDC 30 to changes in the load, the load current is measured, and added to the battery charging current command, as shown in FIG. 12.

Saturation Effects: Commanded Torque Limits (i.e. Torque Allocation)

The HVPDC 30 treats the torque allocation as a limit, (see saturation block 114 shown in FIG. 12). The HCPDC 30 manages the associated wind-up with an anti-windup compensator 116.

### Saturation Effects: Electrical Machine Power vs Speed Limits

As shown in equation 9, the power of the generator is a function of its speed. At lower speeds the generator may not be able to produce the necessary power/current to charge the HV battery 46 at maximum rate. Using the Speed vs Power characteristics of the generator, the HVPDC 30 compares the achievable power, and corresponding current, to the commanded charge current at block 124, and selects the lesser of the two for the regulation setpoint. At the same time, the HVPDC 30 broadcasts the speed 118 at which maximum battery charging is possible, to the vehicular controller 20. If possible, the vehicular controller 20 can command the engine control unit (ECU) 22 and/or transmission control unit (TCU) 24 to increase the speed at which the HVEM 26 is driven.

### Protection Features

This control strategy 200 of the HVPDC 20 implements several protection features to prevent battery damage and HV bus brown-out.

### Battery Overvoltage Protection

The desired charging current from the HV battery 46, decreases with temperature, SoC and voltage. As the SoC reaches 100%, or a cell voltage reaches maximum, the desired charging current converges to zero. However, it may not be advantageous to reach 100% SoC, i.e., leaving extra capacity for regeneration. When the desired SoC is reached, the HVPDC 30 sets the current command to zero.

### Generation—Voltage Mode (Generator Only Mode)

In the case where the HV battery management system (HV BMS) 46c takes the battery offline, the HVPDC 30 will switch from battery current control to generator voltage control. When the HV BMS 46c broadcasts the imminent opening of the battery's internal contacts, HVPDC 30 sets the desired charge current to zero, switches to a voltage compensator, and sets the voltage command to bus voltage. Setting the voltage command to the actual bus voltage reduces the change-over transient. Torque Allocation is no longer applicable, in this degraded mode.

### Simulation

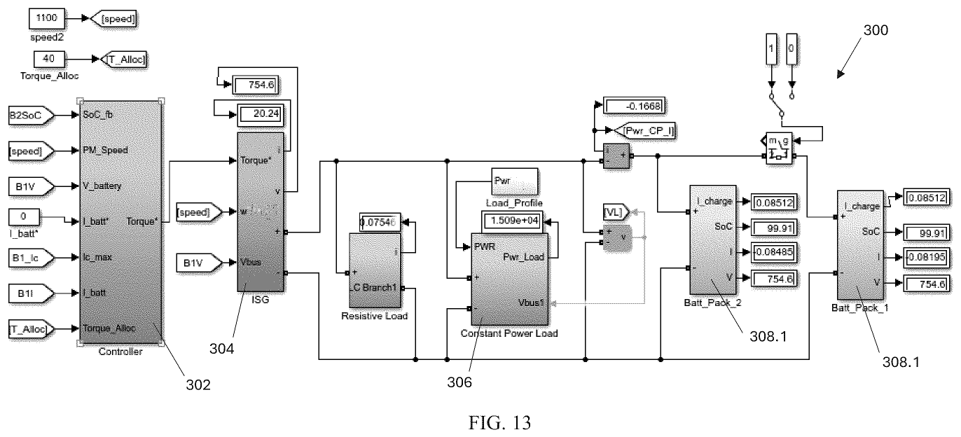

FIG. 13 is a schematic representation of an exemplary HV Subsystem 300 identifying its major components and their inputs and outputs which include:
1. HVPDC 302
   Inputs: Load Current/Voltage, Battery info (SoC, Current, Max Charge Current), Rotor Speed, Torque Allocation
   Outputs: Commanded ISG Inverter Torque
2. HVEM Drive Mode (drive) 304
   Inputs: Torque Command from HVPDC
   Outputs: HV Bus Current (Idc)
3. HVEM Power Generation Mode (load) 306
   Inputs: Dynamic Power profile
   Outputs: Power, Current and Voltage
4. Batteries 308.1, 308.2

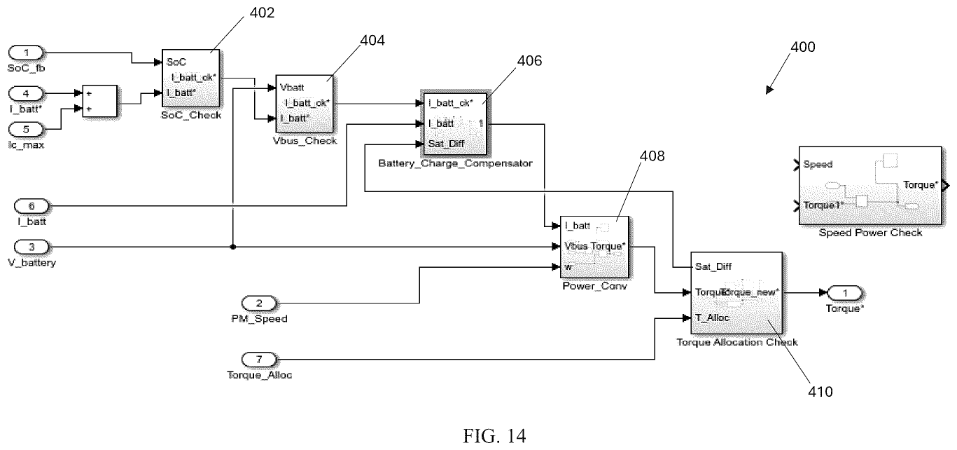

FIG. 14 is a schematic representation of an exemplary Battery Current Controller 400 identifying its major elements and their inputs and outputs which include:
1. SoC Check 402
   Inputs: Soc, I_batt*
   Outputs: I_batt_ok*
2. HV Bus Check 404
   Inputs: I_batt*, V_batt
   Outputs: I_batt_ok*
3. Battery Charge Compensation 406
   Inputs: I_batt*, I_batt, Set_Diff
   Outputs:
4. Power Conversion 408
   Inputs: I_batt, V_buss_torque, ω
   Outputs:
5. Torque Allocation Check 410
   Inputs: Torque_new*, T_alloc
   Outputs: Set_Diff, Torque

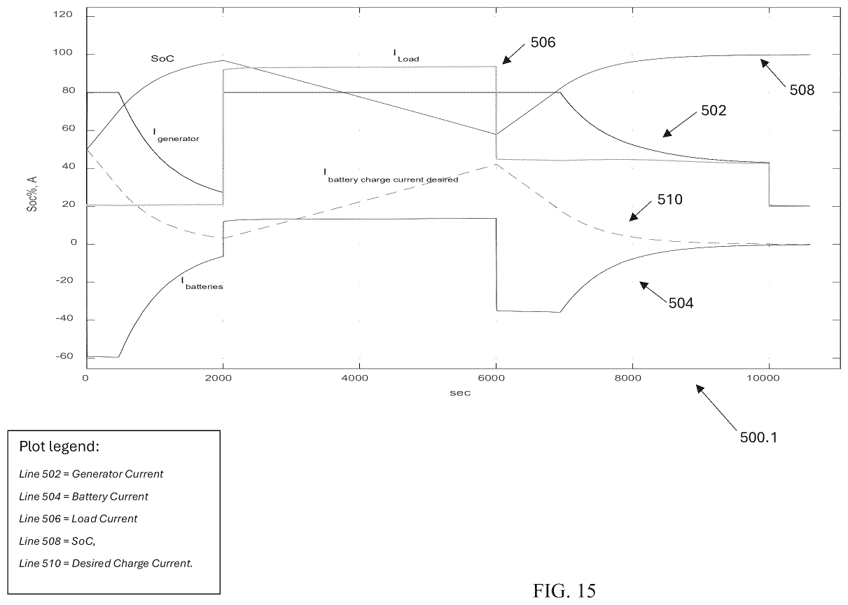

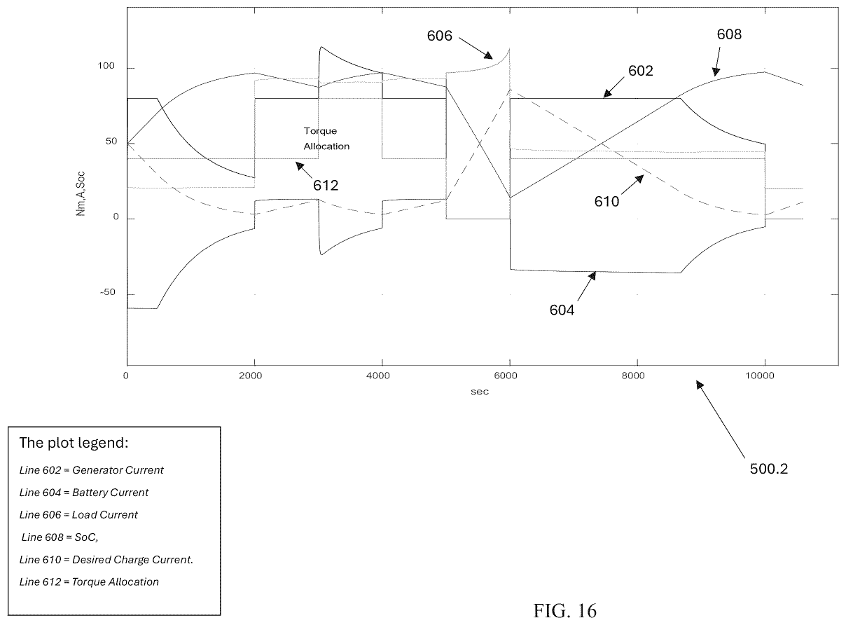

Results 500.1 are presented for a first simulation in FIG. 15. The initial state: i) batteries at low SoC (40%); ii) torque allocation is constant; and iii) a continuous load is applied. For the first 500 seconds, the actual battery charging current (line 502, generator current) is less than the desired charging current, due to the torque allocation. After a period of charging of the battery (line 504, battery current), there is enough torque allocated for the HVPDC 30 to command the ISG to produce enough current to meet the desired charge current and maintain the load (line 506, load current). After approximately 2000 seconds, the battery SoC reaches 90% (line 508, SoC), at which time the constant load is increased (step in the line 506). Due to a torque allocation of less than 100% requested, the ISG is unable to meet the constant load demand, and power is pulled from the batteries to maintain the load. At 6000 seconds the constant load is reduce, allowing the ISG to begin battery charging, but not at the desired rate until ~7000 seconds. After 8000 seconds, the SoC reaches 100%, and the desired charge current request (line 510, desired charge current) goes to zero.

Results 500.2 are presented for a second simulation in FIG. 16. The Torque Allocation changes over the run cycle (line 512, torque allocation). At approximately 3000 seconds the Torque Allocation is doubled, allowing the HVPDC 30 to command the ISG to produce enough power to supply the increased load and begin charging the batteries. However, at 4000 seconds the Torque Allocation is cut in half, and again the batteries discharge to support the load. At 5000 seconds the Torque Allocation goes to zero, and as a result the HVPDC 20 commands the ISG current to zero. The load is being entirely sourced by the batteries. At 6000 seconds, the batteries SoC drops to 20%, and the Torque Allocation is restored. With the drop in load, the HVPDC 20 commands the ISG to produce enough current to start charging the batteries, however, not at the desired rate.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of current regulation for a high voltage subsystem including a high voltage electric machine (HVEM) and a high voltage battery on a high voltage floating bus in a vehicle having a powertrain selectively driven by an internal combustion engine (ICE) and operably coupled to the HVEM, the method comprising:
determining an available torque value for the ICE;
measuring a driving torque value for propulsion of the vehicle;
receiving a battery charge command including a desired charge current;
operating the high voltage subsystem in a voltage regulation mode to regulate a current generated by the HVEM on the high voltage floating bus when the ICE is generating sufficient torque to propel the vehicle and to charge the HV battery; and
operating the high voltage subsystem in a torque allocation mode to regulate the current generated by the HVEM on the high voltage floating bus, wherein the HVEM is selectively operated to generate a supplemental torque for assisting the ICE and to regulate the current on the high voltage floating bus for maintaining a state of charge for the high voltage battery.
